(19) United States
(12) Patent Application Publication
(10) Pub. No.: US 2026/0303500 A1
(43) Pub. Date: Oct. 1, 2026

(54) SPECIAL PURPOSE NETWORK ADDRESSES FOR MEASUREMENTS IN A DATA CENTER FABRIC

(71) Applicant: Cisco Technology, Inc., San Jose, CA (US)

(72) Inventors: Clarence Andre M. Filsfils, Uccle (BE); Ahmed Mohamed Ahmed Abdelsalam, L’Aquila (IT); Pablo Camarillo Garvia, Madrid (ES); Carmine Scarpitta, Santa Marina (IT)

(73) Assignee: Cisco Technology, Inc., San Jose, CA (US)

(21) Appl. No.: 19/563,639

(22) Filed: Mar. 11, 2026

Related U.S. Application Data
(60) Provisional application No. 63/777,238, filed on Mar. 25, 2025.

(51) Int. Cl. H04L 43/0852; H04L 69/164

(52) U.S. Cl. CPC H04L 43/0852; H04L 69/164

(57) ABSTRACT

In one implementation, a device receives, at a port of the device, a measurement packet from a sender in the network. The device obtains a destination address from the measurement packet. The device replaces, as a dataplane operation, the destination address of the measurement packet with an updated destination address associated with the sender. The device sends the measurement packet back to the sender using the updated destination address.

### RELATED APPLICATIONS

The present disclosure claims priority to U.S. Prov. Appl. Ser. No. 63/777,238, filed on Mar. 25, 2025, entitled “SPECIAL PURPOSE NETWORK ADDRESSES FOR MEASUREMENTS IN A DATA CENTER FABRIC,” by Filsfils, et al., the contents of which are incorporated herein by reference.

### TECHNICAL FIELD

The present disclosure relates generally to network compute fabrics and, more particularly to special purpose network addresses for measurements in a data center fabric.

### BACKGROUND

In modern artificial intelligence (AI) and high-performance computing (HPC), fabric resources are not unlimited. This means that different AI model training and other computing tasks often need to be scheduled, resulting in some of the tasks having to wait for execution. Indeed, recent studies estimate that approximately 33% of the processing time for all AI tasks is attributable to waiting on backend network delays.

Generally, to perform measurements in a network, the source and the destination need to cooperate. For instance, two-way measurements typically entail the source sending probe packets towards a receiver that reflects the packets back to the source. One example of such a measurement protocol is the Two-Way Active Measurement Protocol (TWAMP). Under TWAMP, the receiver/reflector does the following: 1.) swap the source and destination address of the packets, 2.) swap the source and destination ports of the packets, and 3.) perform additional packet processing, such as copying the sequence number, timestamp, etc.

Currently, a TWAMP reflector relies on User Datagram Protocol (UDP) ports to pass a TWAMP packet to its CPU for processing. Doing so, though, means that there is no line rate implementation. In addition, implementing this behavior in its network interface controller (NIC) would require the NIC to pass the packet to the host CPU. In many AI data center fabric deployments, though, this may not be allowed and the packet must be processed by the NIC.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example of a user interfacing with an artificial intelligence (AI) model;

FIG. 4 illustrates an example architecture for an AI agent;

FIG. 5 illustrates an example network or compute fabric for performing AI model training and high-performance computing (HPC) tasks; and

FIG. 6 illustrates an example simplified procedure for using special purpose network addresses for measurements in a data center fabric.

### DESCRIPTION OF EXAMPLE IMPLEMENTATIONS

### Overview

According to one or more implementations of the disclosure, a device receives, at a port of the device, a measurement packet from a sender in the network. The device obtains a destination address from the measurement packet. The device replaces, as a dataplane operation, the destination address of the measurement packet with an updated destination address associated with the sender. The device sends the measurement packet back to the sender using the updated destination address.

Other implementations are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

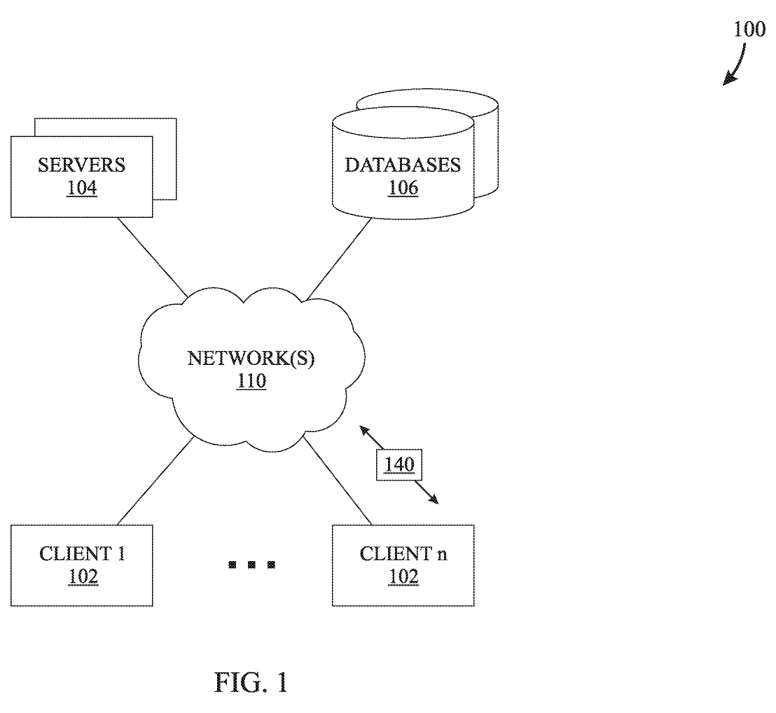

FIG. 1 is a schematic block diagram of an example simplified computing system (e.g., the computing system 100), which includes client devices 102 (e.g., a first through nth client device), one or more servers 104, and databases 106 (e.g., one or more databases), where the devices may be in communication with one another via any number of networks (e.g., network(s) 110). The network(s) 110 may include, as would be appreciated, any number of specialized networking devices such as routers, switches, access points, etc., interconnected via wired and/or wireless connections. For example, client devices 102, the one or more servers 104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, the one or more servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user’s data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

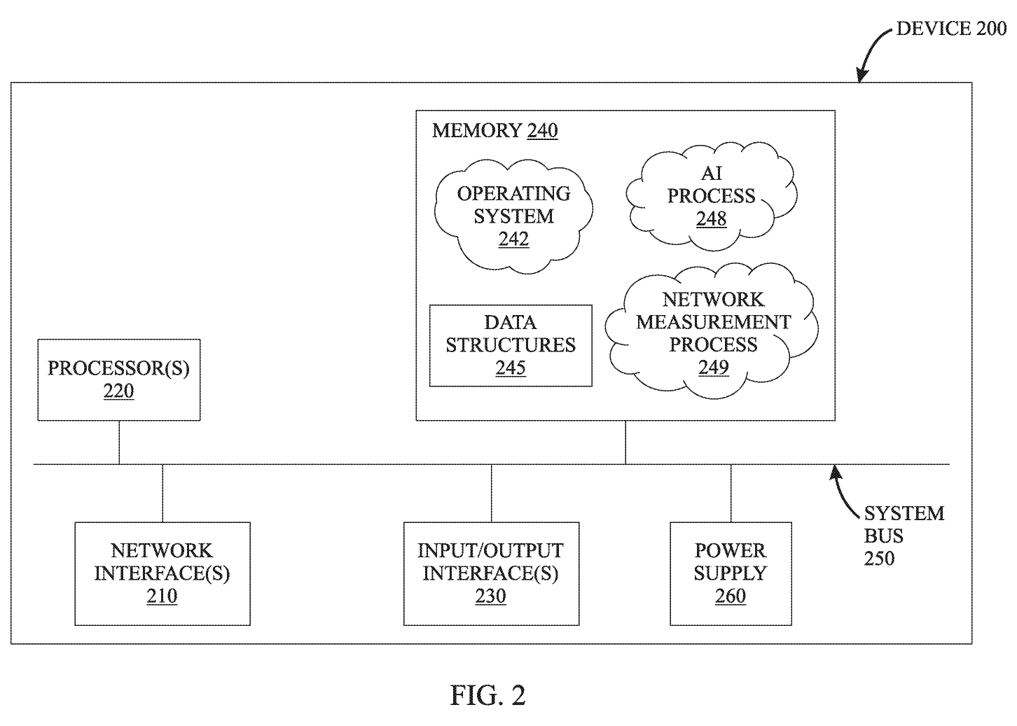

FIG. 2 is a schematic block diagram of an example node/device 200 (e.g., an apparatus) that may be used with one or more implementations described herein, e.g., as any of the devices shown in FIG. 1 above. Device 200 may comprise one or more network interfaces, such as interfaces 210 (e.g., wired, wireless, network interfaces, etc.), at least one processor (e.g., processor 220), and a memory 240 interconnected by a system bus 250, as well as a power supply 260 (e.g., battery, plug-in, etc.).

The interfaces 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise an AI process 248 and/or a network measurement process 249, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

Network measurement process 249 includes computer executable instructions executed by processor 220 to collect measurements within a network. In various implementations, network measurement process 249 may do so by sending probes via the network, which allows for the collection of various metrics regarding the path that the probes traversed (e.g., delay, loss, jitter, etc.). This may be done in a one-way manner, whereby the receiving node performs the measurement calculations or in a two-way manner whereby the receiving node returns the probe packets, allowing the sending node to assess the metrics in both directions. In various implementations, network measurement process 249 may leverage a suitable measurement protocol to perform its measurements, such as Two-Way Active Measurement Protocol (TWAMP).

In various implementations, as detailed further below, AI process 248 and/or network measurement process 249 may include computer executable instructions that, when executed by processor 220, cause device 200 to perform the techniques described herein. To do so, in some implementations, AI process 248 and/or network measurement process 249 may utilize AI/machine learning. In general, AI/machine learning is concerned with the design and the development of techniques that take as input empirical data (such as network statistics and performance indicators) and recognize complex patterns in these data. One very common pattern among these techniques is the use of an underlying model M, whose parameters are optimized for minimizing the cost function associated to M, given the input data. For instance, in the context of classification, the model M may be a straight line that separates the data into two classes (e.g., labels) such that M = a*x + b*y + c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, AI process 248 and/or network measurement process 249 may use one or more supervised, unsupervised, or semi-supervised AI/machine learning models. Generally, supervised learning entails the use of a training set of data that is used to train the model to apply labels to the input data. For example, the training data may include sample configurations labeled with textual metadata. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example AI/machine learning techniques that AI process 248 and/or network measurement process 249 could use may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, AI process 248 and/or network measurement process 249 may also use one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of machine unlearning, AI process 248 may be a component of, use, and/or be utilized in the management of prompts/access to a generative model to perform layer attribution, perform layer sensitivity assessment, remove capabilities from a previously trained model, retain model performance, etc. based on a conversational input from a user (e.g., voice, text, etc.). Example generative approaches can include, but are not limited to, generative adversarial networks (GANs), large language models (LLMs) and other foundation models, diffusion models, transformer models, and the like.

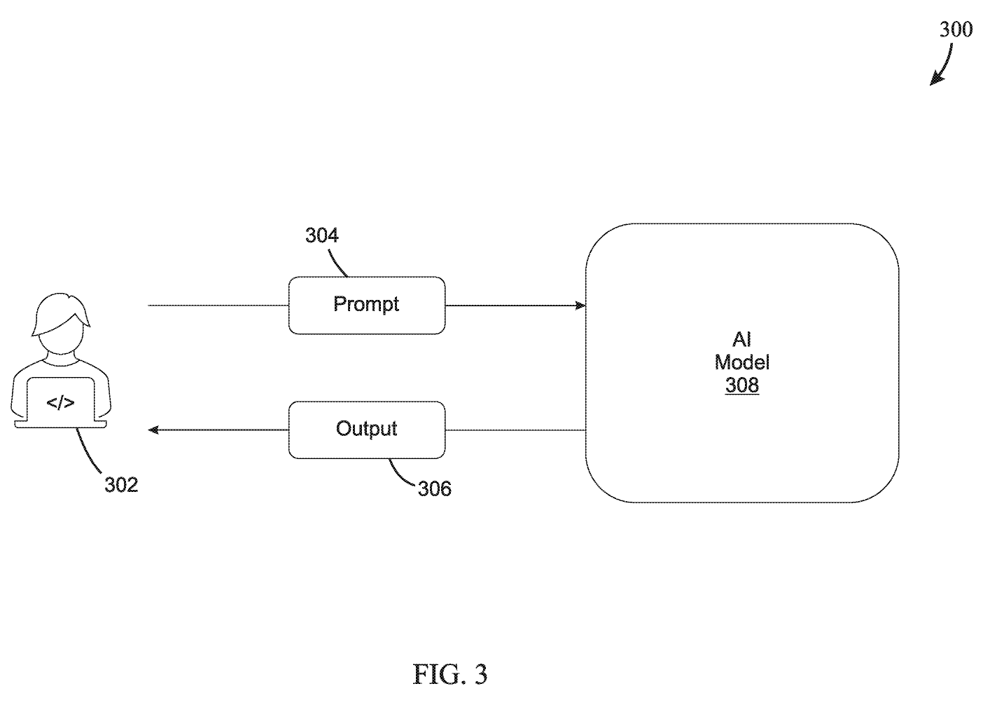

FIG. 3 illustrates an example 300 for interfacing with an AI model, in various implementations. In example 300, a user 302 may send a prompt 304 (e.g., a query, a query augmented with additional data, documents, and/or images, etc.) to an AI model 308. The AI model 308 may be configured to process a prompt 304 to generate an output 306 to satisfy the prompt 304.

AI model 308 may be a model configured to apply its trained algorithms to generate a response (e.g., output 306) based on the prompt 304 provided. More specifically, AI model 308 may be trained on a training dataset 310 and, once trained, be deployed for inference. For instance, in some cases, AI model 308 may take the form of a large language model (LLM) or other foundation model, diffusion-based model, combinations thereof, or the like.

The output 306 may be the result produced by AI model 308 (e.g., by the application of AI model 308 to the prompt 304). This output can vary depending on the model’s configuration and the task at hand. For example, the output 306 may include one or more of a generated and/or synthesized image, a text response, a classification and/or prediction, etc.

As would be appreciated, AI agents are also capable of interacting with generative models, such as AI model 308, which may be integrated directly into the agent or accessed via an API. Indeed, the recent breakthroughs in large language models (LLMs), such as GPT-4, as well as other generative models, represent new opportunities across a wide spectrum of industries. More specifically, the ability of these models to follow instructions now allow for interactions with tools (also called plugins) that are able to perform tasks such as searching the web, executing code, etc. In addition, agents can be written to perform complex tasks by chaining multiple calls to one or more LLMs. For example, a first step can consist in formulating a plan in natural language, and subsequent steps in executing on this plan by writing code to call application programming interfaces (APIs) or libraries.

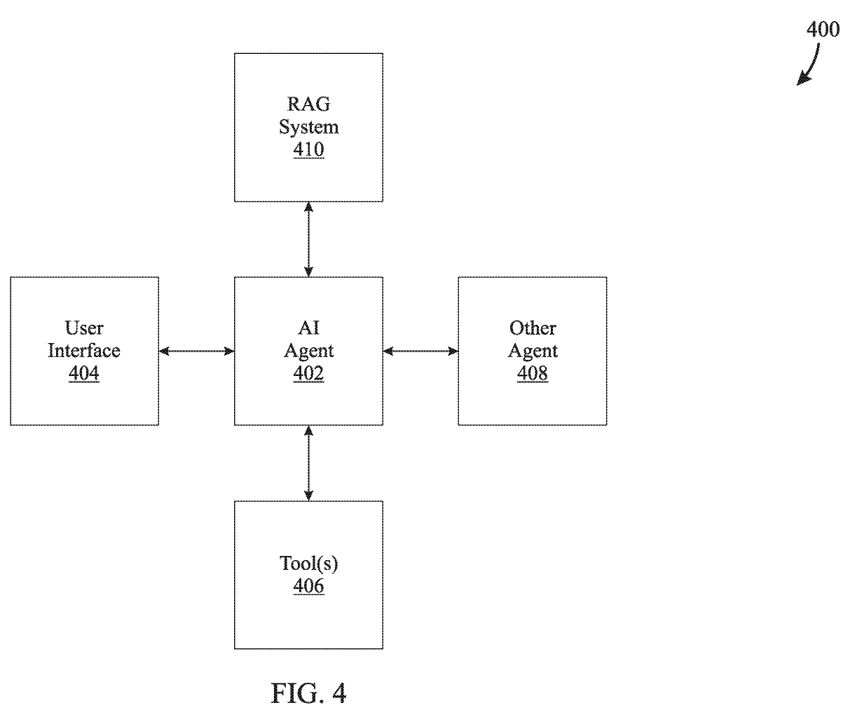

FIG. 4 illustrates an example architecture 400 for an artificial intelligence (AI) agent, according to various implementations. At the core of architecture 400 is AI agent 402, which may be implemented through execution of AI process 248.

As shown, AI agent 402 may interact with a user via a user interface 404. For instance, a user may issue a prompt to AI agent 402 that seeks an answer to a question, performance of a certain task, or the like. In turn, AI agent 402 may use its associated model to formulate a response.

Also as shown, AI agent 402 may interact with tools 406. In general, tools 406 may take the form of interfaces that allow AI agent 402 to interact with any number of systems, in its efforts to produce a response for its input request. For instance, tools 406 may allow AI agent 402 to perform searches (e.g., web searches, searches within a given application or database, etc.), send control commands, or perform other actions, as needed.

In various implementations, AI agent 402 may also be part of an agentic system whereby multiple AI agents interact with one another to formulate a response to an input request. Indeed, the tools, models, etc. available to any given agent may differ across the agentic system. Consequently, different agents may have different capabilities and specialties. Thus, in some implementations, AI agent 402 may also interact with other agent 408, to aid in formulating a final response to its input request. Typically, other agent 408 is executed by a different device than that of the device executing AI agent 402, meaning that AI agent 402 and other agent 408 may communicate via a computer network. In other implementations, though, both agents may be executed by the same device, in further implementations.

For instance, assume that other agent 408 uses a model that has be specialized using knowledge about computer networks and interfaces with tools capable of interacting with a computer network (e.g., to retrieve information, make configuration changes, etc.). Now, assume that the user of user interface 404 issues a query to AI agent 402 asking why the performance of their videoconferencing application is poor. Further, assume that AI agent 402 uses a model that has been specialized on knowledge about the videoconferencing application and able to interact with that application via tools 406. If its initial assessment of the operation of the videoconferencing application is that everything appears to be performing well at the server level, AI agent 402 may then issue a request to other agent 408, to see whether the root cause of the poor performance is the computer network itself.

In some implementations, AI agent 402 may also interact with, or include, a retrieval augmented generation (RAG) system, such as RAG system 410. In general, RAG systems operate by enhancing a prompt for input to a generative model (e.g., an LLM) with additional context. Typically, underlying a RAG system is a dataset of documents or other information that is in a particular domain. For instance, consider the case of AI agent 402 generating a prompt that asks its LLM to make an assessment regarding a computer network. In the case of a general LLM, the LLM may not have specialized knowledge regarding the devices in the network (e.g., command line interface commands, information about the topology of the network, etc.). In such a case, RAG system 410 may modify the prompt, prior to input to the LLM, to provide this additional context, thereby improving the quality of the response and avoiding hallucinations. Typically, a RAG system stores this contextual information in a vector database for quick retrieval using semantic searching.

Indeed, LLMs and other modern AI models are capable of performing a wide variety of tasks. In addition, agentic systems may leverage such models to perform an even larger set of tasks.

However, training an AI model and performing other high-performance computing (HPC) tasks is not straightforward, as network or compute fabric resources are not unlimited. This means that different AI model training and other computing tasks often need to be scheduled, resulting in some of the tasks having to wait for execution. Indeed, recent studies estimate that approximately 33% of the processing time for all AI tasks is attributable to waiting on backend network delays.

Common network implementations for connecting front-end CPU-based networks and backend GPU-based HPC networks to facilitate data transfer and high-performance computing tasks include High-Speed Ethernet, InfiniBand, NVLink, Peripheral Component Interconnect Express (PCIe), and Fibre Channel (FC), among others. When it comes to AI workloads, a front-end network scheduler is typically used to schedule and orchestrate AI-related workloads ranging from model training to inferencing and data processing. This scheduling often entails coordinating various resources and services, managing job queues, and ensuring that the right data and computational resources are available.

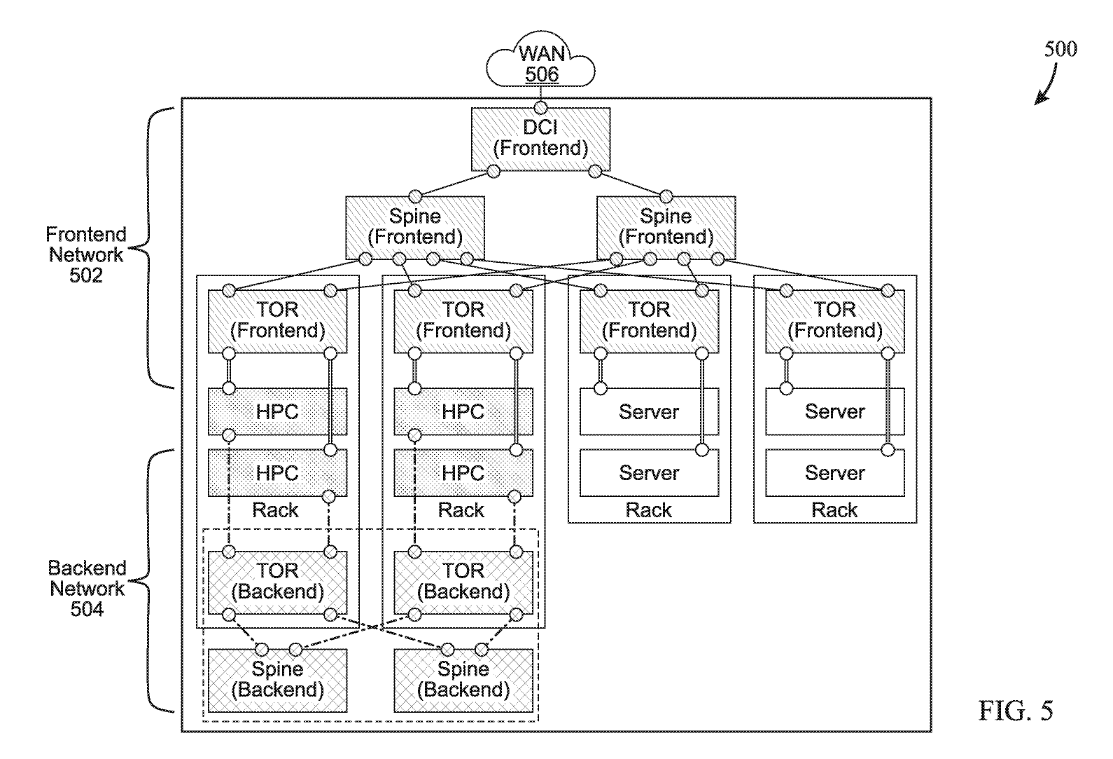

By way of example, FIG. 5 illustrates an example network or compute fabric 500 for performing AI model training and HPC tasks, according to various implementations. As shown, network or compute fabric 500 may include a frontend network 502 and a backend network 504. Network or compute fabric 500 may also be connected to a WAN 506, allowing for remote access.

For instance, frontend network 502 may include various components such as a data center interconnect (DCI), any number of frontend spines, a plurality of top-of-rack (TOR) switches, etc. Likewise, backend network 504 may include HPC clusters, servers, its own backend TOR switches, etc. on the racks, as well as its own backend spines. As would be appreciated, the specific configuration and components of frontend network 502 and backend network 504 may differ as desired.

As noted above, to perform measurements in a network, such as the network shown in FIG. 5, the source and the destination need to cooperate. For instance, two-way measurements typically entail the source sending probe packets towards a receiver that reflects the packets back to the source. One example of such a measurement protocol is the Two-Way Active Measurement Protocol (TWAMP). Under TWAMP, the receiver/reflector does the following: 1.) swap the source and destination address of the packets, 2.) swap the source and destination ports of the packets, and 3.) perform additional packet processing, such as copying the sequence number, timestamp, etc.

Currently, a TWAMP reflector relies on User Datagram Protocol (UDP) ports to pass a TWAMP packet to its CPU for processing. Doing so, though, means that there is no line rate implementation. In addition, implementing this behavior in its network interface controller (NIC) would require the NIC to pass the packet to the host CPU. In many AI data center fabric deployments, though, this may not be allowed and the packet must be processed by the NIC.

### SPECIAL PURPOSE NETWORK ADDRESSES FOR MEASUREMENTS IN A DATA CENTER FABRIC

According to various implementations, the techniques herein allow for the use of TWAMP in data centers, particularly in AI and HPC fabrics, through the allocation of special (IPv6) addresses.

Illustratively, the techniques described herein may be performed by hardware, software, and/or firmware, such through execution of network measurement process 249, which may include computer executable instructions executed by the processor 220 (or independent processor of interfaces 210) to perform functions relating to the techniques described herein, e.g., in conjunction with AI process 248.

Specifically, in some implementations, a device receives, at a port of the device, a measurement packet from a sender in the network. The device obtains a destination address from the measurement packet. The device replaces, as a dataplane operation, the destination address of the measurement packet with an updated destination address associated with the sender. The device sends the measurement packet back to the sender using the updated destination address.

Operationally, in various implementations, the techniques herein allow for TWAMP to be used in data center networks (e.g., AI and HPC fabrics) by allocating two new network addresses, such as IPv6 addresses, for the purposes of performing the TWAMP measurements. The Internet Assigned Numbers Authority (IANA) allows the allocation of such special purposes addresses.

By way of example, assume that address IPV6_ADDR_1 and address IPV6_ADDR_2 are allocated such that IPV6_ADDR_1 = IPV6_ADDR_2 & MASK. For instance, IPV6_ADDR_1 = XX…XXX1 & IPV6_ADDR_2 = XX…XXX0 in the case the MASK can be FFFF…FFFE.

IPV6_ADDR_1 may be bound to DATAPLANE BEHAVIOR_1 which receives the packet, consume it and process the fields for measurements (Liveness, Loss, latency).

Conversely, IPV6_ADDR_2 may be bound to DATAPLANE BEHAVIOR_2 which receives the packet and reflect it. The reflection is behavior is done in the data plane by masking IPV6_ADDR_2 which can done at line rate. The result of the mask will be an updated DA = IPV6_ADDR_2 & MASK = IPV6_ADDR_1. The packet is forwarded at line rate back to the source (IPV6_ADDR_1). The source assigns IPV6_ADDR_1 to its loopback. In AI and other HPC fabrics in a data center, the source can be the top-of-rack (ToR) device, in some implementations. The receiver assigns IPV6_ADDR_2 to its loopback. In AI and other HPC fabrics in a data center, the source can be the GPU NIC, in some implementations. The source (e.g., ToR) generates packets with IPV6_ADDR_2. The packets are timestamped at egress. The receiver (GPU NIC) receives packets with IPV6_ADDR_2 and performs DATAPLANE BEHAVIOR_2. Packet DA becomes IPV6_ADDR_1. The source (ToR) receives packets with IPV6_ADDR_1 and performs DATAPLANE BEHAVIOR_1 and records all performance measurements.

As would be appreciated, this approach allows for ToR to NIC measurements in a data center fabric. However, the techniques herein also have general applicability in any network, in further implementations.

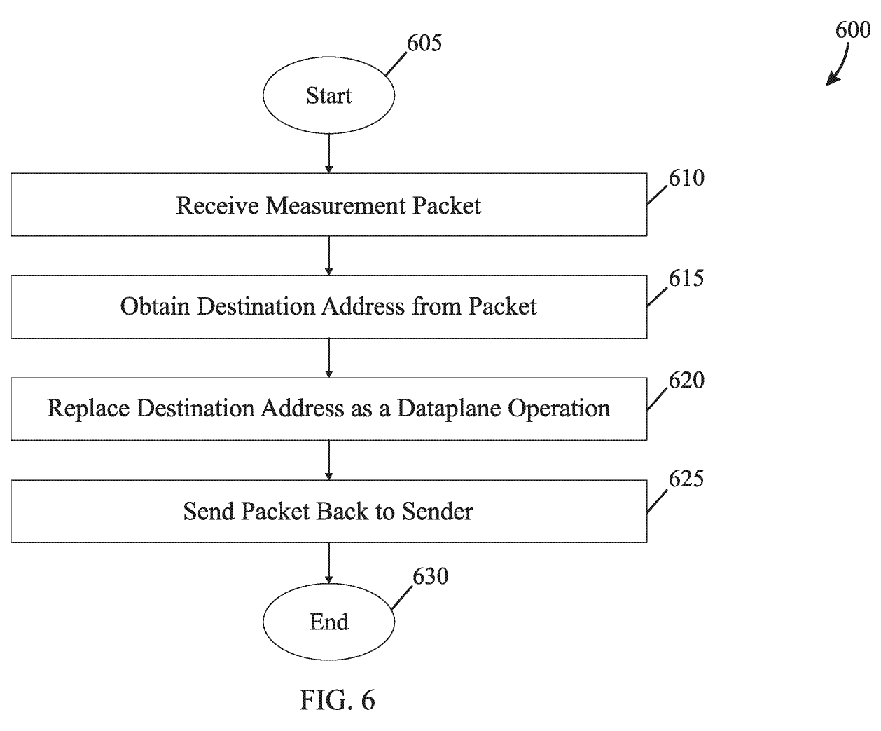

FIG. 6 illustrates an example simplified procedure for using special purpose network addresses for measurements in a data center fabric, in accordance with one or more implementations described herein. For example, a non-generic, specifically configured device (e.g., device 200), may perform procedure 600 (e.g., a method) by executing stored instructions (e.g., AI process 248 and/or network measurement process 249). The procedure 600 may start at step 605, and continues to step 610, where, as described in greater detail above, the device (e.g., a controller, server, NIC, TOR, etc.) may receive, at a port of the device, a measurement packet from a sender in the network. In various implementations, the measurement packet is a Two-Way Active Measurement Protocol (TWAMP) packet. In such a case, the port of the device may also be a User Datagram Protocol (UDP) port. In one implementation, the measurement packet includes a timestamp indicative of when the sender transmitted the measurement packet.

At step 615, as detailed above, the device obtains a destination address from the measurement packet. In some instances, the device is a network interface card (NIC) associated with a graphics processing unit (GPU) in the network. Further, the sender may be a top of rack (TOR) device in the network.

At step 620, the device replaces, as a dataplane operation, the destination address of the measurement packet with an updated destination address associated with the sender, as described in greater detail above. According to various implementations, the device may do so by applying a predefined mask to the destination address of the measurement packet. In some implementations, the device performs this dataplane operation without sending the measurement packet to a central processing unit of the device.

At step 625, as detailed above, the device sends the measurement packet back to the sender using the updated destination address. In some implementations, the device sends the measurement packet back to the sender as a forwarding operation. In various instances, the sender, on receipt of the measurement packet, computes one or more of: a liveliness, loss, or latency metric for a path between itself and the device.

Procedure 600 may then end at step 630.

It should be noted that while certain steps within procedure 600 may be optional as described above, the steps shown in FIG. 6 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative implementations that provide for special purpose network addresses for measurements in a data center fabric, it is to be understood that various other adaptations and modifications may be made within the intent and scope of the implementations herein. In addition, while certain processes are shown, other suitable processes may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

What is claimed is:

1. A method comprising:
receiving, at a port of a device in a network, a measurement packet from a sender in the network;
obtaining, by the device, a destination address from the measurement packet;
replacing, by the device and as a dataplane operation, the destination address of the measurement packet with an updated destination address associated with the sender; and
sending, by the device, the measurement packet back to the sender using the updated destination address.

2. The method as in claim 1, wherein the measurement packet is a Two-Way Active Measurement Protocol (TWAMP) packet.

3. The method as in claim 2, wherein the port of the device is a User Datagram Protocol (UDP) port.

4. The method as in claim 1, wherein the device performs the dataplane operation without sending the measurement packet to a central processing unit of the device.

5. The method as in claim 1, wherein replacing the destination address of the measurement packet with an updated destination address associated with the sender comprises:
applying a predefined mask to the destination address of the measurement packet.

6. The method as in claim 1, wherein the device is a network interface card (NIC) associated with a graphics processing unit (GPU) in the network.

7. The method as in claim 6, wherein the sender is a top of rack (TOR) device in the network.

8. The method as in claim 1, wherein the device sends the measurement packet back to the sender as a forwarding operation.

9. The method as in claim 1, wherein the measurement packet includes a timestamp indicative of when the sender transmitted the measurement packet.

10. The method as in claim 1, wherein the sender, on receipt of the measurement packet, computes one or more of: a liveliness, loss, or latency metric for a path between itself and the device.

11. An apparatus, comprising:
a processor configured to execute one or more processes; and
a memory configured to store a process that is executable by the processor, the process when executed configured to:
receive, at a port of the apparatus, a measurement packet from a sender in a network;
obtain a destination address from the measurement packet;
replace, as a dataplane operation, the destination address of the measurement packet with an updated destination address associated with the sender; and
send the measurement packet back to the sender using the updated destination address.

12. The apparatus as in claim 11, wherein the measurement packet is a Two-Way Active Measurement Protocol (TWAMP) packet.

13. The apparatus as in claim 12, wherein the port of the apparatus is a User Datagram Protocol (UDP) port.

14. The apparatus as in claim 11, wherein the apparatus performs the dataplane operation without sending the measurement packet to a central processing unit of the apparatus.

15. The apparatus as in claim 11, wherein the apparatus replaces the destination address of the measurement packet with an updated destination address associated with the sender by:
applying a predefined mask to the destination address of the measurement packet.

16. The apparatus as in claim 11, wherein the apparatus is a network interface card (NIC) associated with a graphics processing unit (GPU) in the network.

17. The apparatus as in claim 16, wherein the sender is a top of rack (TOR) device in the network.

18. The apparatus as in claim 11, wherein the apparatus sends the measurement packet back to the sender as a forwarding operation.

19. The apparatus as in claim 11, wherein the measurement packet includes a timestamp indicative of when the sender transmitted the measurement packet.

20. A tangible, non-transitory, computer-readable medium storing program instructions that cause a device in a network to execute a process comprising:
receiving, at a port of the device in the network, a measurement packet from a sender in the network;
obtaining, by the device, a destination address from the measurement packet;
replacing, by the device and as a dataplane operation, the destination address of the measurement packet with an updated destination address associated with the sender; and
sending, by the device, the measurement packet back to the sender using the updated destination address.
